(19) United States
(12) Patent Application Publication
(10) Pub. No.: US 2005/0097870 A1
(43) Pub. Date: May 12, 2005

(54) Air cleaning furniture

(75) Inventor: Paul A. Moshenrose, Ocean Springs, MS (US)

Correspondence Address: SETTER OLLILA, LLC, 2060 BROADWAY, SUITE 300, BOULDER, CO, 80302, US

(73) Assignee: Oreck Holdings, LLC

(21) Appl. No.: 10/702,819

(22) Filed: Nov. 6, 2003

(51) Int. Cl. B01D 46/00

(52) U.S. Cl. 55/385.1

(57) ABSTRACT

An air cleaning furniture is provided according to an embodiment of the invention. The air cleaning furniture includes a furniture item and an air cleaning device integrated into the furniture item. The air cleaning furniture performs both a furniture function and an air cleaning function.

### TECHNICAL FIELD

The present invention relates to an air cleaning furniture, and more specifically, to a furniture item that integrates an air cleaning device.

### BACKGROUND OF THE INVENTION

Air cleaning devices are devices that remove impurities from the air. Common types of impurities can include smoke, dust, pollen and other allergens, pet hair and pet dander, airborne mold and bacteria, etc. They are often used by persons suffering from allergies or persons who are sensitive to impurities. They are used by persons in settings where impurities are at higher than normal levels. They are used by persons for medical reasons, such as to avoid infection and/or irritation of the respiratory system. They are used by persons having respiratory problems.

In one common prior art approach, an air filter is provided that draws air through a filter element in order to remove impurities from the air. The prior art air filter device is typically a stand-alone device, comprising a fan unit, a filter(s), and a case. The prior art air filter therefore is a strictly utilitarian device that is used only for air filtration.

However, this prior art approach has drawbacks. A prior art air filter device does not perform any function other than air cleaning. Air cleaning devices that are large enough to sufficiently clean the air in a large room are typically large and therefore fairly obtrusive items. Such a large air filtration device can take up significant floor and living space. In addition, there have been no efforts to disguise or stylize prior art air filter devices. Therefore, a typical prior art air filter device is a large and conspicuous item in a room.

### SUMMARY OF THE INVENTION

An air cleaning furniture is provided according to an embodiment of the invention. The air cleaning furniture comprises a furniture item and an air cleaning device integrated into the furniture item. The air cleaning furniture performs both a furniture function and an air cleaning function.

An air cleaning furniture is provided according to an embodiment of the invention. The air cleaning furniture comprises a furniture item and an air cleaning device integrated into the furniture item. The air cleaning device comprises an air duct, a fan unit located in the air duct and configured to create airflow in the air duct, and one or more filter elements positioned in the airflow. The one or more filter elements perform the air cleaning function. The air cleaning furniture performs both a furniture function and an air cleaning function.

An air cleaning furniture is provided according to an embodiment of the invention. The air cleaning furniture comprises a furniture item and an air cleaning device integrated into the furniture item. The air cleaning device comprises an air duct, a fan unit located in the air duct and configured to create airflow in the air duct, and an ultraviolet light source positioned in the airflow. The ultraviolet light source performs the air cleaning function. The air cleaning furniture performs both a furniture function and an air cleaning function.

An air cleaning furniture is provided according to an embodiment of the invention. The air cleaning furniture comprises a furniture item and an air cleaning device integrated into the furniture item. The air cleaning device comprises an air duct, a fan unit located in the air duct and configured to create airflow in the air duct, and an air ionizer positioned in the airflow. The air ionizer performs the air cleaning function. The air cleaning furniture performs both a furniture function and an air cleaning function.

An air cleaning furniture is provided according to an embodiment of the invention. The air cleaning furniture comprises a furniture item and an air cleaning device integrated into the furniture item. The air cleaning device comprises an air duct, a fan unit located in the air duct and configured to create airflow in the air duct, and an ozone generator positioned in the airflow. The ozone generator performs the air cleaning function. The air cleaning furniture performs both a furniture function and an air cleaning function.

### BRIEF DESCRIPTION OF THE DRAWINGS

The same reference number represents the same element on all drawings. It should be noted that the drawings are not to scale.

FIG. 1 shows an air cleaning furniture according to an embodiment of the invention;

FIG. 2 shows detail of an air cleaning device according to an embodiment of the invention;

FIG. 3 shows a furniture item according to an embodiment of the invention;

FIG. 4 shows a furniture item according to another embodiment of the invention;

FIG. 5 shows a furniture item according to yet another embodiment of the invention; and

FIG. 6 shows a furniture item according to yet another embodiment of the invention.

### DETAILED DESCRIPTION OF THE INVENTION

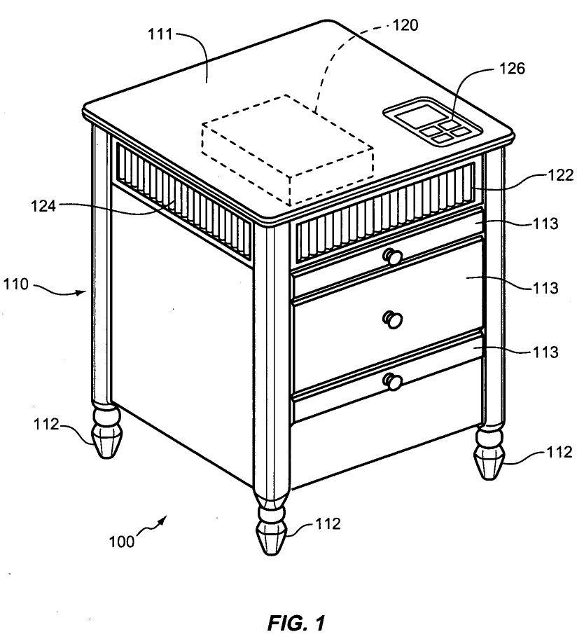

FIG. 1 shows an air cleaning furniture 100 according to an embodiment of the invention. The air cleaning furniture 100 includes a furniture item 110 and an air cleaning device 120. The air cleaning furniture 100 further includes an air inlet 122 of the air cleaning device 120, an air outlet 124, and a control panel 126. The air cleaning device 120 is integrated into and is a part of the furniture item 110. The air cleaning device 120 can comprise an internal device, or can be built at least partially into an external surface of the furniture item 110.

The furniture item 110 can comprise any furniture. A dictionary definition of furniture is a furnishing or the movable things in a room, apartment, etc., which equip it for living. The furniture item 110 therefore can comprise a utilitarian item, a decorative item, or both.

The furniture item 110 can include several characteristic features. In one embodiment, the furniture item 110 includes a substantially horizontal support surface 111. Typical furniture items that include a substantially horizontal support surface 111 are desks, nightstands, bureaus, hutches, credenzas, tables, end tables, coffee tables, furniture stands such as plant stands, shelves and bookcases, etc.

In another embodiment, the furniture item 110 includes one or more drawers 113. The one or more drawers 113 can be used for storage. Alternatively, the drawers can comprise integral, removable filter elements, or can provide filter element access. Typical furniture items that include one or more drawers 113 are desks, nightstands, bureaus, hutches, credenzas, etc.

In yet another embodiment, the furniture item 110 can include one or more doors 113. The one or more doors 113 can provide access to internal storage of the furniture item 110, and/or can provide access to the air cleaning device 120. The access can be for maintenance, such as for cleaning and/or replacement of filter elements, etc. Typical furniture items that include one or more doors 113 are desks, nightstands, bureaus, hutches, credenzas, etc.

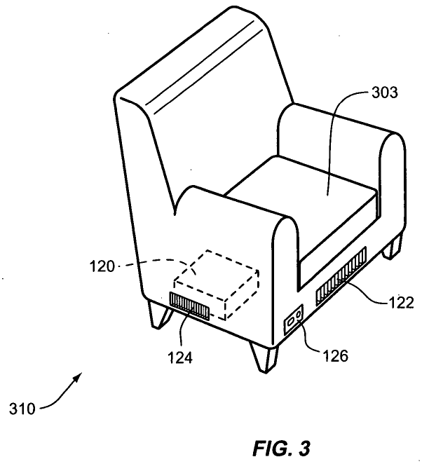

In yet another embodiment, the furniture item 110 can include one or more seat portions 303 (see FIG. 3). Typical furniture items that include a seat portion 303 are chairs, loveseats, sofas, sectional sofas, bench seats, footstools, ottomans, etc.

In yet another embodiment, the furniture item 110 can include one or more support portions 112, such as the legs 112 shown in FIG. 1, for example. The furniture item 110 therefore can comprise a freestanding furniture item, and can further support other items. The support portions 112 can include wheels or other mobility features for easy movement of the furniture item 110. Typical furniture items that include one or more support portions 112 are desks, nightstands, bureaus, hutches, credenzas, tables, end tables, coffee tables, furniture stands such as plant stands, shelves and bookcases, chairs, loveseats, sofas, sectional sofas, bench seats, footstools, ottomans, etc.

The control panel 126 includes controls for operating the air cleaning device 120. The control panel 126 is in communication with the air cleaning device 120. The control panel 126 can include controls for setting the level of airflow, for setting the level and/or type of air cleaning process, can include indicators and power controls, etc. The control panel 126 can be analog or digital, can be programmable or non-programmable, and can be remote controlled or self-contained. The function status of the air cleaning device 120 can be indicated on the control panel 126 by markings, by light-emitting diodes (LEDs) or a LCD display, or various other methods.

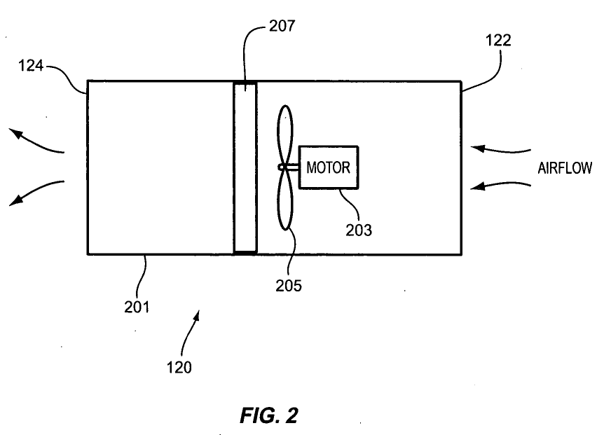

FIG. 2 shows detail of the air cleaning device 120 according to an embodiment of the invention. The air cleaning device 120 can be designed to remove any type and size of impurity from the air. The air cleaning device 120 can comprise an air cleaner, an air filter, an air purifier, an air sterilizer, or any device capable of removing impurities from the air. The air cleaning device 120 comprises an air duct 201, the air inlet 122, the air outlet 124, a motor 203 and impeller 205, and one or more air cleaning elements 207. The motor 203 and 205 generate airflow through the air duct 201 from the air inlet 122 to the air outlet 124. The one or more air cleaning elements 207 are positioned in the airflow, either upstream or downstream of the motor 203 and impeller 205.

The one or more air cleaning elements 207 perform the air cleaning operation. The one or more air cleaning elements 207 can be fixed in the air duct 201, or can be removable for purposes of cleaning and replacement. In one embodiment, an air cleaning element 207 is formed in a sliding tray or movable portion, similar to a drawer 113.

An air cleaning element 207 of the one or more air cleaning elements 207 can comprise any type of air cleaning element. In one embodiment, an air cleaning element comprises an air filter. The air filter can comprise a fiber, a mesh, or a woven filter, for example. The air filter can comprise a High Efficiency Particulate Air (HEPA) filter (typically able to remove particulate down to about 0.3 micron in diameter), an allergen air filter, an electrostatic air filter, a charcoal filter, an anti-microbial filter, etc. An allergen is any substance which causes an allergic state or allergic reaction in a subject. In addition, the air filter can be treated with a germicide, fungicide, bactericide, insecticide, etc., in order to kill germs, mold, bacteria, viruses, and other airborne living organisms (including microorganisms).

In another embodiment, an air cleaning element 207 of the one or more air cleaning elements 207 comprises an ultraviolet air purifier/sterilizer. The air cleaning element 207 in this embodiment includes an ultraviolet light source, wherein living organisms are killed by emitted ultraviolet light. By locating the ultraviolet light source in the air duct 201, whether in the center or built substantially into a surface of the air duct 201, the airflow can be at least partially cleaned by killing living organisms in the airflow.

In yet another embodiment, an air cleaning element 207 of the one or more air cleaning elements 207 comprises an ionizer air purifier/sterilizer. The air cleaning element 207 in this embodiment ionizes air molecules (i.e., the air molecules become negatively charged). The negatively charged air molecules can transfer a charge to impurities suspended in the air, and the charged particles aggregate together and sink out of the air. An ionizer apparatus can be located in the air duct 201 or can be built substantially into a surface of the air duct 201. Consequently, the airflow can be at least partially cleaned by killing living organisms in the airflow through the ionization process.

In yet another embodiment, an air cleaning element 207 of the one or more air cleaning elements 207 comprises an ozone generator air purifier/sterilizer. The air cleaning element 207 in this embodiment converts normally occurring stable oxygen in the air (i.e., O₂) to ozone (O₃), an unstable form of oxygen. Ozone typically decomposes back to O₂ oxygen within about thirty minutes through the process of oxidization with other particles in the air. Ozone is a powerful oxidant, and the oxidation process is very effective for killing bacteria, viruses, spores, and fungi. Ozone can also neutralize organic carcinogens and many odors. The ozone generator can be located in the air duct 201 or can be built substantially into a surface of the air duct 201. Consequently, the airflow can be at least partially cleaned by killing microorganisms in the airflow through the ozone oxidation process.

It should be understood that the air cleaning device 120 can include multiple air cleaning elements 207. Therefore, the air cleaning device 120 can include one or more of the filters, the ultraviolet light source, the ionizer, and the ozone generator, as discussed above. As a result, the airflow passing through the air cleaning device 120 can be more highly cleaned and sterilized than an air cleaning device 120 employing only one of the devices described above.

FIG. 3 shows a furniture item 310 according to another embodiment of the invention. In this embodiment, the furniture item 310 comprises a chair 310, including legs 112 and a seat portion 303. The air cleaning device 120, the air inlet 122, the air outlet 124, the control panel 126, and the air duct 201 (not shown) are formed as part of the chair 310. The air inlet 122, the air outlet 124, and the control panel 126 can all be formed as part of an exterior surface of the chair 310. The relative positions of the air inlet 122, the air outlet 124, and the control panel 126 are shown for example only, and can be located on other regions of the chair 310. The chair 310 can be any manner of chair-type furniture, including a wooden chair, a stuffed chair, an easy chair, a recliner, etc.

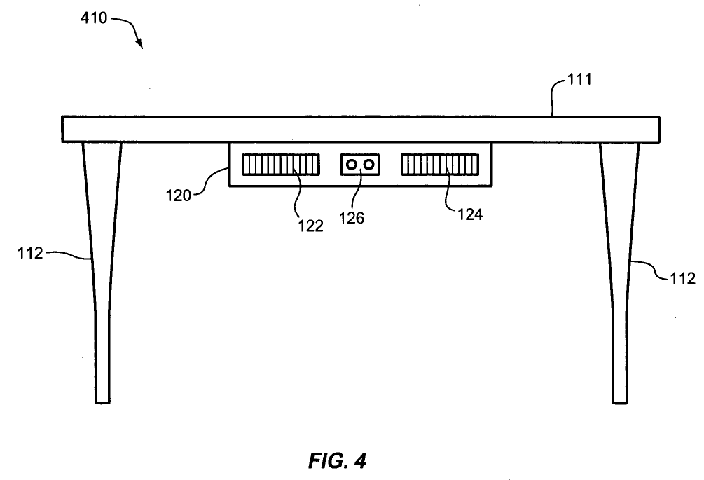

FIG. 4 shows a furniture item 410 according to another embodiment of the invention. In this embodiment, the furniture item 410 comprises a table 410, including a substantially horizontal support surface 111 and legs 112. The air cleaning device 120, the air inlet 122, the air outlet 124, the control panel 126, and the air duct 201 (not shown) are formed as part of the table 410. The air inlet 122, the air outlet 124, and the control panel 126 can all be formed as part of an exterior surface of the table 410, such as the bottom surface, as shown. The relative positions of the air inlet 122, the air outlet 124, and the control panel 126 are shown for example only, and can be located on other regions of the table 410. The table 410 can be any manner of table-type furniture, including a dining table, a coffee table, an end table, a folding, collapsible, or portable table, etc.

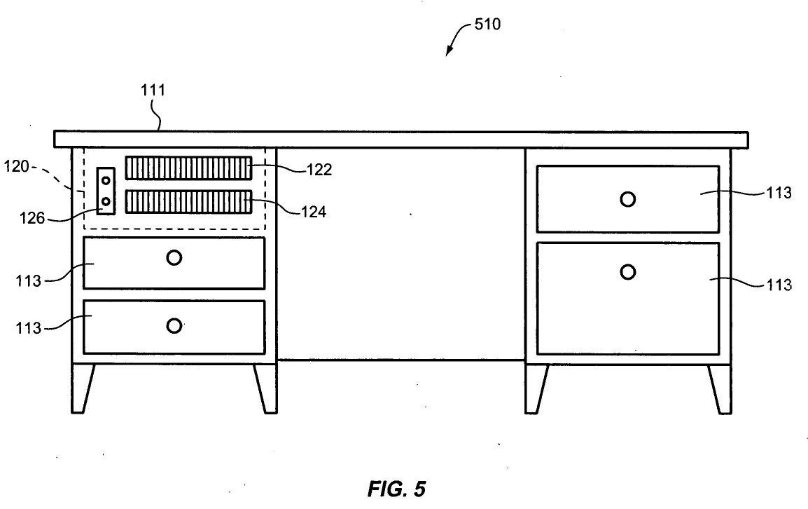

FIG. 5 shows a furniture item 510 according to another embodiment of the invention. In this embodiment, the furniture item 510 comprises a desk 510, including a substantially horizontal support surface 111 and one or more drawers or doors 113. The air cleaning device 120, the air inlet 122, the air outlet 124, the control panel 126, and the air duct 201 (not shown) are formed as part of the desk 510. The air inlet 122, the air outlet 124, and the control panel 126 can all be formed as part of an exterior surface of the desk 510. The relative positions of the air inlet 122, the air outlet 124, and the control panel 126 are shown for example only, and can be located on other regions of the desk 510. Likewise, the arrangement and number of drawers/doors 113 can be altered as needed. The desk 510 can be any manner of desk-type furniture, including a flat top desk, a roll-top desk, a hideaway desk, a secretary desk, a credenza, etc.

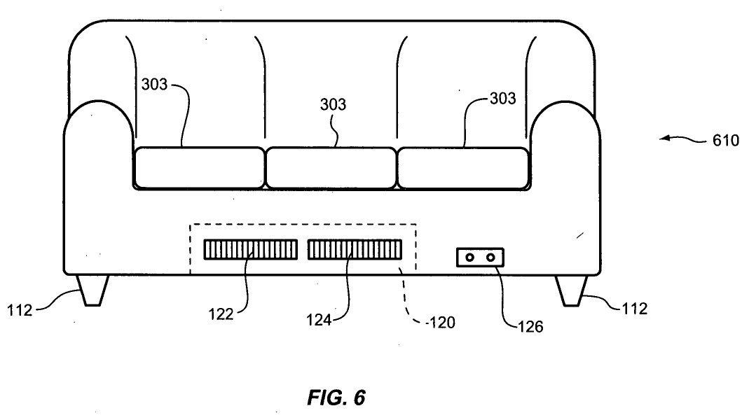

FIG. 6 shows a furniture item 610 according to another embodiment of the invention. In this embodiment, the furniture item 610 comprises a sofa 610, including legs 112 and multiple seat portions 303. The air cleaning device 120, the air inlet 122, the air outlet 124, the control panel 126, and the air duct 201 (not shown) are formed as part of the sofa 610. The air inlet 122, the air outlet 124, and the control panel 126 can all be formed as part of an exterior surface of the sofa 610. The relative positions of the air inlet 122, the air outlet 124, and the control panel 126 are shown for example only, and can be located on other regions of the sofa 610. The sofa 610 can be any manner of sofa-type furniture, including a loveseat, a sectional sofa, a recliner, etc.

The various embodiments of the invention can be implemented to provide several advantages, if desired. The air cleaning furniture 100 can provide one or more types of air cleaning functions, including one or more types of filtering and sterilizing. The air cleaning device 120 is integrated into and is part of the furniture item. The air cleaning device 120 can be fully contained within the furniture item, and can provide the air cleaning function in addition to the function of the furniture item. The air cleaning device therefore does not take up additional floor or room space, is unobtrusive, and can cooperate with any style elements of the furniture item. As a result, the air cleaning furniture 100 is useful, presentable, and unobtrusive. The air cleaning furniture 100 can be easily used in typical homes, businesses, workplaces, or other institutions.

1. An air cleaning furniture comprising:
a furniture item; and
an air cleaning device integrated into the furniture item, with the air cleaning device comprising:
an air duct; and
an air ionizer positioned in the air duct, wherein the air ionizer performs the air cleaning function;
wherein the air cleaning furniture performs both a furniture function and an air cleaning function.

2. The air cleaning furniture of claim 1, with the air cleaning device further comprising
one or more filter elements positioned in the air duct, wherein the one or more filter elements perform the air cleaning function.

3. The air cleaning furniture of claim 1, with the air cleaning device further comprising
an ultraviolet light source positioned in the air duct, wherein the ultraviolet light source performs the air cleaning function.

4. The air cleaning furniture of claim 1, with the air cleaning device further comprising
a fan unit located in the air duct and configured to create airflow in the air duct.

5. The air cleaning furniture of claim 1, with the air cleaning device further comprising
an ozone generator positioned in the air duct, wherein the ozone generator performs the air cleaning function.

6. The air cleaning furniture of claim 1, wherein the furniture comprises a substantially horizontal support surface.

7. The air cleaning furniture of claim 1, wherein the furniture comprises one or more drawers.

8. The air cleaning furniture of claim 1, wherein the furniture comprises one or more doors.

9. The air cleaning furniture of claim 1, wherein the furniture comprises one or more seat portions.

10. An air cleaning furniture comprising:
a furniture item; and
an air cleaning device integrated into the furniture item, with the air cleaning device comprising:
an air duct;
one or more filter elements positioned in the air duct, wherein the one or more filter elements performs the air cleaning function; and
an air ionizer positioned in the airflow, wherein the air ionizer performs the air cleaning function;
wherein the air cleaning furniture performs both a furniture function and an air cleaning function.

11. The air cleaning furniture of claim 10, wherein the furniture comprises a substantially horizontal support surface.

12. The air cleaning furniture of claim 10, wherein the furniture comprises one or more drawers.

13. The air cleaning furniture of claim 10, wherein the furniture comprises one or more doors.

14. The air cleaning furniture of claim 10, wherein the furniture comprises one or more seat portions.

15. An air cleaning furniture comprising:
a furniture item; and
an air cleaning device integrated into the furniture item, with the air cleaning device comprising:
an air duct;
an ultraviolet light source positioned in the air duct, wherein the ultraviolet light source performs the air cleaning function; and
an air ionizer positioned in the airflow, wherein the air ionizer performs the air cleaning function;
wherein the air cleaning furniture performs both a furniture function and an air cleaning function.

16. The air cleaning furniture of claim 15, wherein the furniture comprises a substantially horizontal support surface.

17. The air cleaning furniture of claim 15, wherein the furniture comprises one or more drawers.

18. The air cleaning furniture of claim 15, wherein the furniture comprises one or more doors.

19. The air cleaning furniture of claim 15, wherein the furniture comprises one or more seat portions.

20. An air cleaning furniture comprising:
a furniture item; and
an air cleaning device integrated into the furniture item, with the air cleaning device comprising:
an air duct; and
an air ionizer positioned in the air duct, wherein the air ionizer performs the air cleaning function;
wherein the air cleaning furniture performs both a furniture function and an air cleaning function.

21. The air cleaning furniture of claim 20, wherein the furniture comprises a substantially horizontal support surface.

22. The air cleaning furniture of claim 20, wherein the furniture comprises one or more drawers.

23. The air cleaning furniture of claim 20, wherein the furniture comprises one or more doors.

24. The air cleaning furniture of claim 20, wherein the furniture comprises one or more seat portions.

25. An air cleaning furniture comprising:
a furniture item; and
an air cleaning device integrated into the furniture item, with the air cleaning device comprising:
an air duct:
an ozone generator positioned in the air duct, wherein the ozone generator performs the air cleaning function; and
an air ionizer positioned in the airflow, wherein the air ionizer performs the air cleaning function;
wherein the air cleaning furniture performs both a furniture function and an air cleaning function.

26. The air cleaning furniture of claim 25, wherein the furniture comprises a substantially horizontal support surface.

27. The air cleaning furniture of claim 25, wherein the furniture comprises one or more drawers.

28. The air cleaning furniture of claim 25, wherein the furniture comprises one or more doors.

29. The air cleaning furniture of claim 25, wherein the furniture comprises one or more seat portions.

30. The air cleaning furniture of claim 10, further comprising a fan unit located in the air duct and configured to create airflow in the air duct.

31. The air cleaning furniture of claim 15, further comprising a fan unit located in the air duct and configured to create airflow in the air duct.

32. The air cleaning furniture of claim 20, further comprising a fan unit located in the air duct and configured to create airflow in the air duct.

33. The air cleaning furniture of claim 25, further comprising a fan unit located in the air duct and configured to create airflow in the air duct.
